(19) United States
(12) Patent Application Publication
(10) Pub. No.: US 2024/0023172 A1
(43) Pub. Date: Jan. 18, 2024

(54) VIRTUAL 5G UE SOFTWARE STACK DISTRIBUTION AND MANAGEMENT SYSTEM

(71) Applicant: T-Mobile Innovations LLC, Overland Park, KS (US)

(72) Inventors: Marouane Balmakhtar, Fairfax, VA (US); Robert Keith Butler, Overland Park, KS (US)

(21) Appl. No.: 17/865,087

(22) Filed: Jul. 14, 2022

(51) Int. Cl. H04W 76/10; H04W 72/04

(52) U.S. Cl. CPC H04W 76/10; H04W 72/042; H04W 72/0453

(57) ABSTRACT

Systems and methods for connecting a user device to a telecommunication network include a user device and a core network management system communicatively coupled to at least one access network and the user device. The core network management system is structured to generate a unique identifier corresponding to the user device, generate a telecommunication network stack based on the unique identifier, the virtual telecommunication network stack including the unique identifier, determine a channel to distribute the telecommunication network stack, and based on the telecommunication network stack, cause the user device to connect to a telecom network using an access network.

### SUMMARY

The present disclosure is directed, in part, to connecting a user device to a telecommunication network, substantially as shown in and/or described in connection with at least one of the figures, and as set forth more completely in the claims.

In aspects set forth herein, a user device is connected to a telecommunication network (e.g., a 5G network). Typically, a user device is connected to the telecommunication network using cellular connectivity over the commercial spectrum. The user device usually has a radio (e.g., a 5G radio) and a subscriber identification card and is intended by design to be a 5G UE. However, here, the user device does not have a radio or a subscriber identification card. Rather, a core network management system generates a telecommunication network stack based on a unique identifier and, based on the telecommunication network stack, causes the user device to connect to a telecom network (e.g., a 5G core network) using an access network.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE SEVERAL VIEWS OF THE DRAWINGS

Illustrative embodiments of the present invention are described in detail below with reference to the attached drawing figures, and wherein:

FIG. 1 depicts an example of a network environment wherein the user devices may reach a Non-3GPP Interworking Function (N3IWF) in accordance with one or more embodiments;

FIG. 2A is a diagram of a network environment including a core network management system in accordance with an example embodiment;

FIG. 2B is a diagram of a network environment including a core network management system in accordance with an example embodiment;

FIG. 2C is a diagram of a network environment including initial distribution of a telecommunication network stack in accordance with an example embodiment;

FIG. 2D is a diagram of a network environment including an update of a telecommunication network stack in accordance with an example embodiment;

FIG. 2E is a diagram of a network environment including a stop of service to a user device in accordance with an example embodiment;

FIG. 2F is a diagram of a network environment including a restart of service to a user device in accordance with an example embodiment;

FIG. 3 depicts a flowchart of an exemplary method for connecting a user device to a telecommunication network in accordance with an example embodiment;

FIG. 4 depicts a flowchart of an exemplary method for updating a user device connected to a telecommunication network in accordance with an example embodiment; and

FIG. 5 depicts an exemplary computing device suitable for use in implementations of aspects herein.

### DETAILED DESCRIPTION

The subject matter of embodiments of the invention is described with specificity herein to meet statutory requirements. However, the description itself is not intended to limit the scope of this patent. The claimed subject matter might be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly described.

In certain aspects, methods are provided for connecting a user device to a telecommunication network. A unique identifier corresponding to a user device is generated. A telecommunication network stack is generated based on the unique identifier, the telecommunication network stack including the unique identifier. A channel to distribute the telecommunication network stack is determined. The user device is caused to connect to a telecom network based on the telecommunication network stack.

Advantageously, connecting a user device to a telecommunication network permits a user device to attach to or otherwise connect to an access network and/or network core of the telecommunication network utilizing a subscriber identification module free (SIM-free) identifier and without a radio (e.g., a 5G radio).

In one aspect, a method is provided for connecting a user device to a telecommunication network. The method includes generating, by a core network management system, a unique identifier corresponding to a user device. The method also includes generating a telecommunication network stack based on the unique identifier, the telecommunication network stack including the unique identifier. The method also includes determining a channel to distribute the telecommunication network stack. The method further includes based on the telecommunication network stack, causing the user device to connect to a telecom network.

In another aspect, a computer-readable storage media having computer-executable instructions embodied thereon is provided that, when executed by one or more processors, cause the processors to perform various steps. The processors are caused to generate a unique identifier corresponding to a user device. The processors are also caused to generate a telecommunication network stack based on the unique identifier, the telecommunication network stack including the unique identifier. The processors are further caused to determine a channel to distribute the telecommunication network stack. The processors are further caused to, based on the telecommunication network stack, cause the user device to connect to an access network and a telecom network.

In yet another aspect, a system is provided for connecting a user device to a telecommunication network. The system includes a user device and a core network management system communicatively coupled to at least one access network and the user device. The core network management system generates a unique identifier corresponding to the user device. The core network management system also generates a telecommunication network stack based on the unique identifier, the telecommunication network stack including the unique identifier. The core network management system also determines a channel to distribute the telecommunication network stack. The core network management system further, based on the telecommunication network stack, causes the user device to connect to a telecom network.

Throughout this disclosure, several acronyms and shorthand notations are used to aid the understanding of certain concepts pertaining to the associated system and methods. These acronyms and shorthand notations are intended to help provide an easy methodology of communicating the ideas expressed herein and are not meant to limit the scope of aspects herein.

Embodiments herein may be embodied as, among other things: a method, system, or set of instructions embodied on one or more computer-readable media. Computer-readable media include both volatile and nonvolatile media, non-transitory and transitory media, removable and non-removable media, and contemplate media readable by a database, a switch, and various other network devices. Computer-readable media includes media implemented in any way for storing information. Examples of stored information include computer-useable instructions, data structures, programmatic circuitry, and other data representations. Media examples include RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data momentarily, temporarily, or permanently. Embodiments may take the form of a hardware embodiment, or an embodiment combining software and hardware. Some embodiments may take the form of a computer-program product that includes computer-useable or computer-executable instructions embodied on one or more computer-readable media.

“Computer-readable media” may be any available media and may include volatile and nonvolatile media, as well as removable and non-removable media. By way of example, and not limitation, computer-readable media may include computer storage media and communication media.

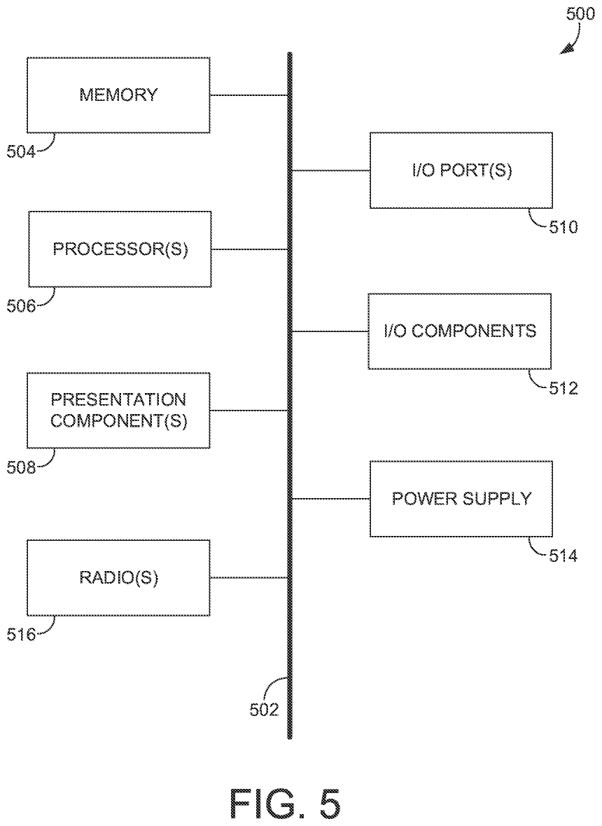

“Computer storage media” may include, without limitation, volatile and nonvolatile media, as well as removable and non-removable media, implemented in any method or technology for storage of information, such as computer-readable instructions, data structures, program circuitry, or other data. In this regard, computer storage media may include, but is not limited to, Random Access Memory (RAM), Read-Only Memory (ROM), Electrically Erasable Programmable Read-Only Memory (EEPROM), flash memory or other memory technology, CD-ROM, digital versatile disks (DVDs) or other optical disk storage, magnetic cassettes, magnetic tape, magnetic disk storage, or other magnetic storage devices, or any other medium which may be used to store the desired information and which may be accessed by the computing device 500 shown in FIG. 5. Computer storage media does not comprise a signal per se.

“Communication media” may include, without limitation, computer-readable instructions, data structures, program circuitry, or other data in a modulated data signal, such as a carrier wave or other transport mechanism, and may include any information delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, radio frequency (RF), infrared, and other wireless media. Combinations of any of the above also may be included within the scope of computer-readable media.

A “user device” refers to a device employed by an end-user that has the basic capability to communicate using a network (e.g., WiFi, Ethernet) but cannot connect to a mobile service provider network. A “UE” is a “user device” that has the additional capability of being able to connect to a mobile service provider network. In embodiments, the user device may take on any variety of devices, such as a personal computer, laptop computer, tablet, netbook, mobile phone, smart phone, personal digital assistant, wearable device, augmented reality device, fitness tracker, or any other device capable of communicating using one or more resources of the network. The user device may include components such as software and hardware, a processor, a memory, a display component, a power supply or power source, a speaker, a touch-input component, a keyboard, and the like.

An “access network” refers to a network comprised of wireless and wired components that provide communications service coverage to one or more user devices. The network may comprise one or more Non-3GPP access networks including N3IWFs, base stations, and other communication equipment.

Additionally, it will be understood that terms such as “first,” “second,” and “third” are used herein for the purposes of clarity in distinguishing between elements or features, but the terms are not used herein to import, imply, or otherwise limit the relevance, importance, quantity, technological functions, sequence, order, and/or operations of any element or feature unless specifically and explicitly stated as such.

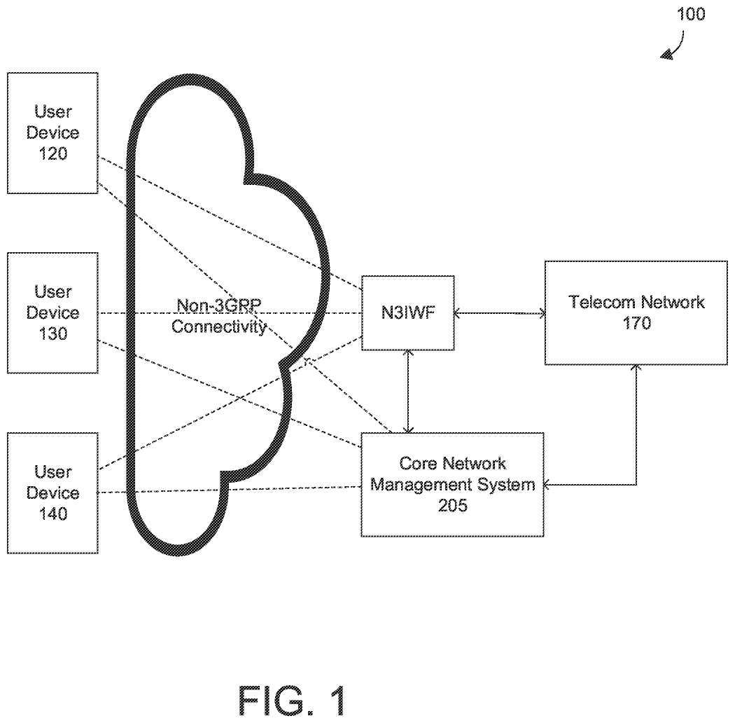

FIG. 1 illustrates an example of a network environment 100 suitable for use in implementing embodiments of the present disclosure. The network environment 100 is but one example of a suitable network environment and is not intended to suggest any limitation as to the scope of use or functionality of the disclosure. Neither should the network environment 100 be interpreted as having any dependency or requirement relating to any one or combination of components illustrated.

The network environment 100 provides service to one or more UE devices (not shown) and can communicate with user devices 120, 130, and 140, although services cannot be provided since the user devices 120, 130, and 140 lack SIMs and 3GPP communication protocols. In some embodiments, the network environment 100 may include a telecom network (e.g., a telecom network 170 such as, but not limited to, 5G core network, a wireless telecommunication network), or portion thereof. The network environment 100 may include one or more devices and components, such as base stations, servers, switches, relays, amplifiers, databases, nodes, etc. which are not shown so as to not confuse other aspects of the present disclosure. Those devices and components may provide connectivity in a variety of implementations. In addition the network environment 100 may be utilized in a variety of manners, such as a single network, multiple networks, or as a network of networks, but, ultimately, is shown as simplified as possible to avoid the risk of confusing other aspects of the present disclosure.

In some embodiments, the user device(s) may take the form of a wireless or mobile device capable of communication via the network environment 100. For example, the user device 120 may take the form of a mobile device capable of communication via a telecom network such as, but not limited to, a wireless telecommunication network. In this regard, the user device(s) may be any computing device that communicates by way of a network, for example, a 4G, LTE, WiMAX, Wi-Fi, 5G, 6G, or any other type of network.

In some embodiments, the network environment 100 may connect subscribers (e.g., current subscribers and/or potential subscribers) to a service provider or a plurality of service providers. Alternatively or additionally, the network environment 100 may be associated with a specific telecommunication provider or a plurality of telecommunication providers that provide services (e.g. 5G, 6G, voice, location, data, etc.) to one or more user devices. For example, the user devices 120 and 130 may be subscribers to a telecommunication service provider, in which the devices are registered or subscribed to receive voice and data services (e.g., receive content that may be streamed, downloaded, etc.) over the network environment 100. The network environment 100 may include any communication network providing voice and/or data service(s), such as, for example, a Wi-Fi network, 4G network (LTE, WiMAX, HSDPA), 5G network, or 6G network.

Having described the network environment 100 and components operating therein, it will be understood by those of ordinary skill in the art that the network environment 100 is but one example of a suitable network and is not intended to limit the scope of use or functionality of aspects described herein. Similarly, the network environment 100 should not be interpreted as imputing any dependency and/or any requirements with regard to each component and combination(s) of components illustrated in FIG. 1. It will be appreciated by those of ordinary skill in the art that the number, interactions, and physical location of components illustrated in FIG. 1 are examples, as other methods, hardware, software, components, and devices for establishing one or more communication links between the various components may be utilized in implementations of the present invention. It will be understood to those of ordinary skill in the art that the components may be connected in various manners, hardwired or wireless, and may use intermediary components that have been omitted or not included in FIG. 1 for simplicity's sake. As such, the absence of components from FIG. 1 should not be interpreted as limiting the present invention to exclude additional components and combination(s) of components. Moreover, though components may be represented as singular components or may be represented in a particular quantity in FIG. 1, it will be appreciated that some aspects may include a plurality of devices and/or components such that FIG. 1 should not be considered as limiting the quantity of any device and/or component.

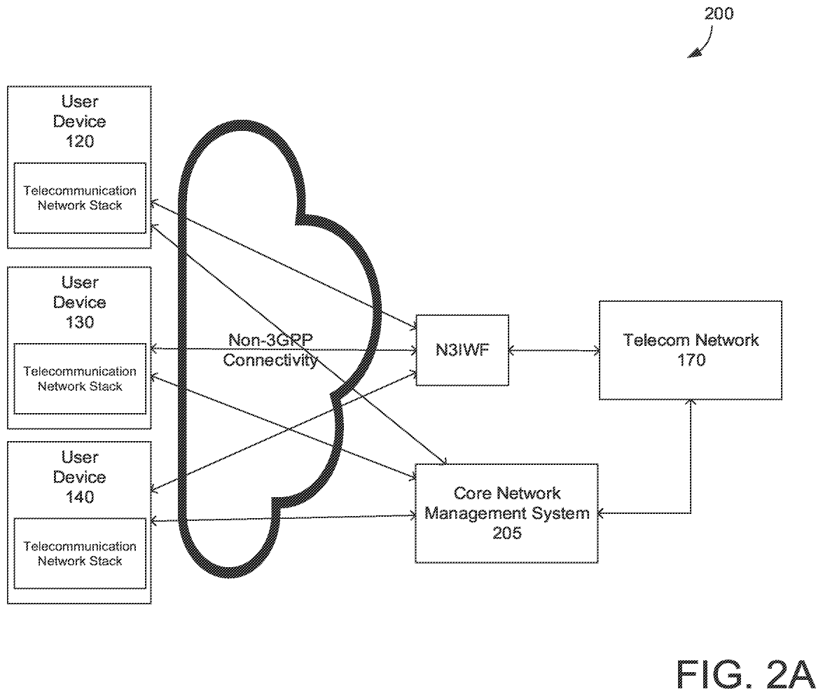

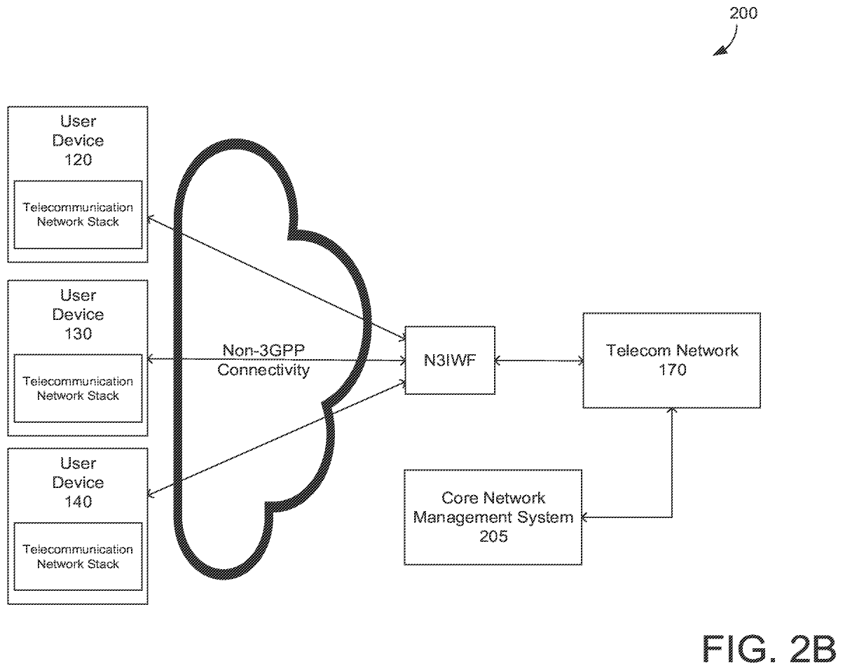

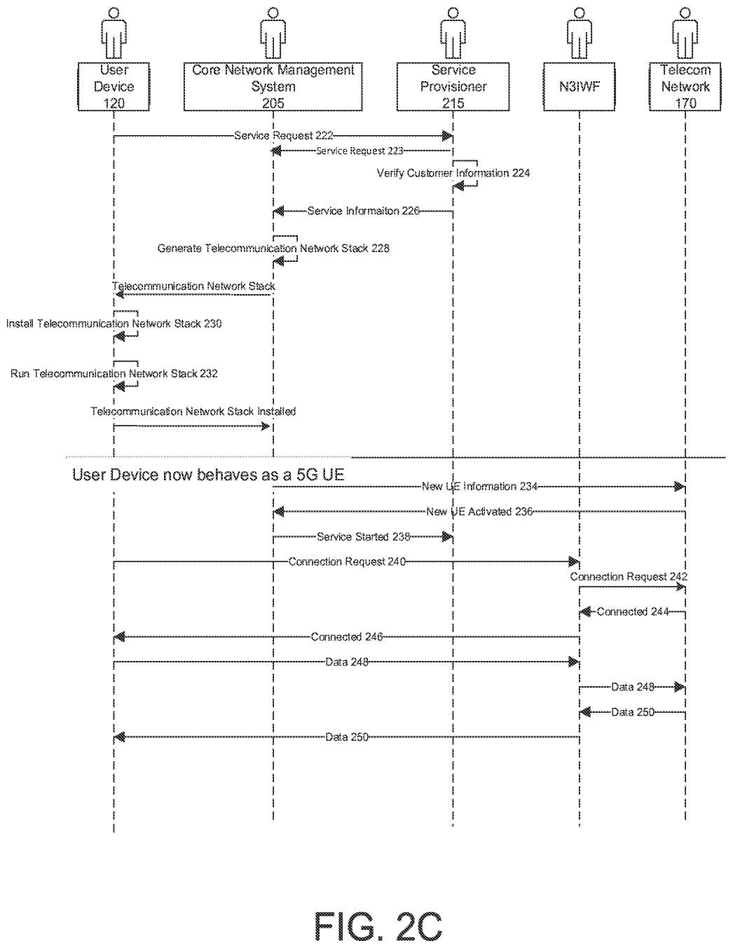

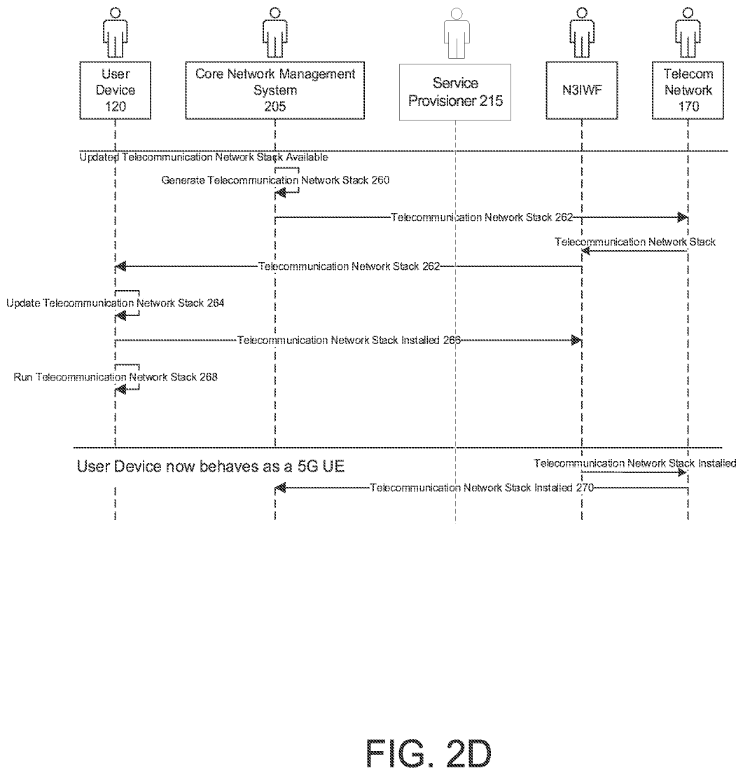

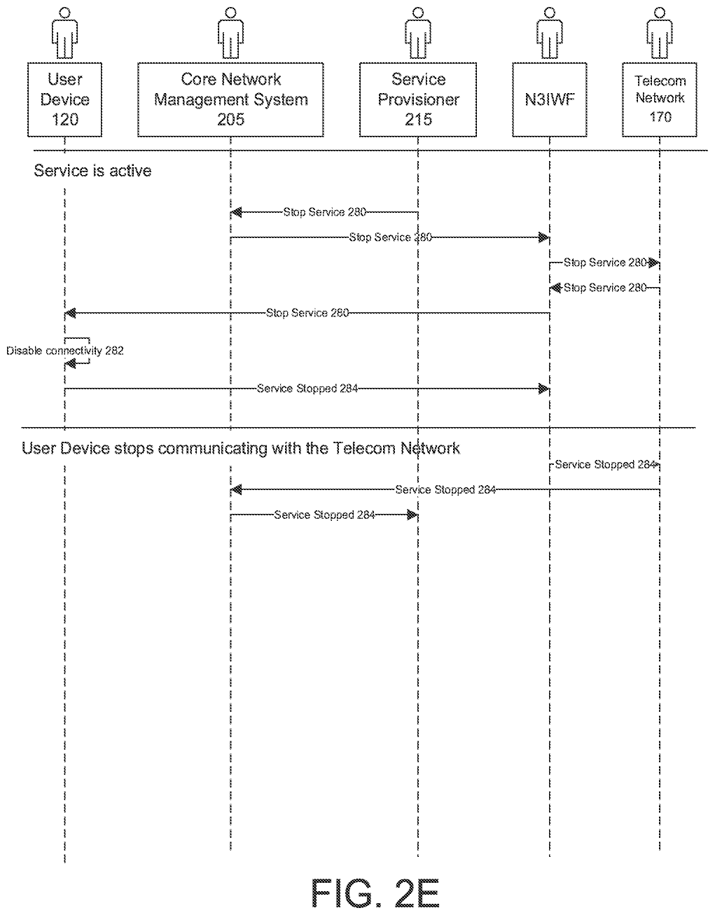

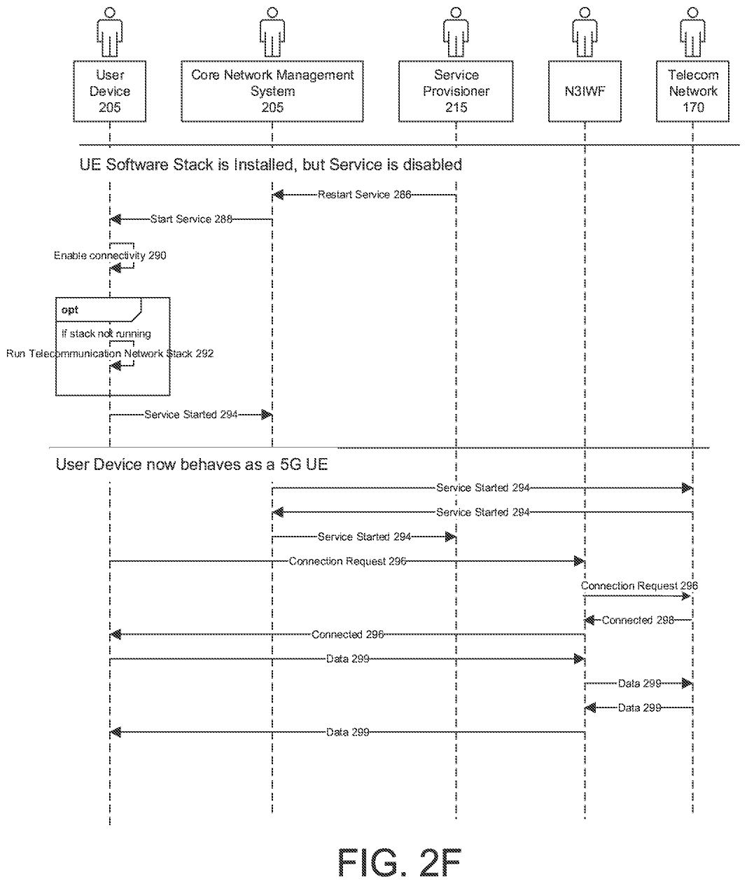

FIGS. 2A-2F are diagrams of the network environment 200 (e.g., a telecommunication environment) according to an example embodiment. In the present embodiment, the network environment 200 includes the telecom network 170, core network management system 205, and user devices 120, 130, and 140. Although the components in the network environment 200 are depicted as single components (e.g., a single core network management system, etc.), in some embodiments, the network environment 200 may include a plurality of such components. The core network management system 205 may be included within, external to, and/or otherwise communicatively coupled to the user devices 120, 130, and 140 directly or indirectly.

In some embodiments, the core network management system (e.g., the core network management system 205) may generate a unique identifier corresponding to a user device (e.g., the user device 120). For example, the core network management system may produce and/or manage unique SIM-free identification (e.g., free of a physical subscriber identification module (SIM) or embedded SIM (eSIM)) information that identifies the user device. The user devices 120, 130, and 140 may include one or more adapters. In some examples, the user devices 120, 130, and 140 may take the form of a generic device that may be free of a radio (e.g., 5G radio), SIM card reader, and/or a SIM card.

In some embodiments, a service request 222 is provided to a service provisioner 215 as shown in FIG. 2C. The service request 222 may be provided by the user device 120. Alternatively or additionally, the service request (e.g., the service request 223) may be provided by the service provisioner 215 to the core network management system 205. The service provisioner 215 may verify the customer information 224. The service provisioner 215 may provide the service information 226 to the core network management system 205.

In some embodiments, the core network management system 205 may generate a telecommunication network stack (e.g., a virtual 5G user device stack and/or a set of Software Development Kits (SDKs) that may enable non-3GPP devices) based on the unique identifier. The telecommunication network stack may include the unique identifier. In this regard, the core network management system 205 may include the unique identification information in the telecommunication network stack. Alternatively or additionally, the core network management system 205 may deliver the unique identifier with the telecommunication network stack. The core network management system 205 may be structured to generate one or more telecommunication network stacks 228 (e.g., the 5G UE Software Stack). For example, the core network management system 205 may create one or more unique client stack instances that correspond to the user device 120. In some embodiments, the telecommunication network stack may be provided to or otherwise received by, for example, the user device 120 and/or a gateway device. Accordingly, the telecommunication network stack may be received and/or provided by a service provider system, cloud system, Wi-Fi, or any other suitable system to the user device(s). In some examples, one or more subsequent telecommunication network stacks (e.g., updated telecommunication network stacks) may be received and/or provided by a service provider system, cloud system, Wi-Fi, or any other suitable system to the user device(s).

The core network management system 205 may determine a channel (e.g., a 5G channel) to distribute the telecommunication network stack (e.g., the 5G UE Software Stack). The channel may include or otherwise take the form of a network distribution channel (e.g., a 5G distribution channel), control plane, and/or user plane. In the control plane, signal traffic (e.g., control packets) may be sent and/or received between the user device 120, telecom network 170, etc. The signal traffic may include one or more messages based on the radio resource control (RRC) protocol. In the user plane, user traffic (e.g., data packets) may be routed, forwarded, sent and/or received based on one or more protocols such as Transmission Control Protocol (TCP), Internet Protocol (IP), User Datagram Protocol (UDP), etc.

The core network management system 205 may manage the creation, distribution, and installation of the telecommunication network stack 230 (e.g., the 5G UE Software Stack) on one or more user devices within reach. The core network management system 205 may determine that a user device is within reach based on the provision of an IP address for the user device. The IP address may be sent from the user device. In some embodiments, a user (e.g., a customer) may provide the IP address through a provider platform (e.g., a carrier website, application, etc.).

The user device 120 may run the telecommunication network stack 232. In some examples, the core network management system 205 may, based on the virtual telecommunication network, cause the user device 120 to connect to the telecom network 170 (e.g., the 5G core network) via an access network (e.g., a 5G access network). The telecommunication network stack 205 (e.g., the 5G UE Software Stack) may be platform agnostic such that the telecommunication network stack 205 may cause the user device 120 to connect, via a connection request 240, to the telecom network 170 regardless of the carrier and/or the service provider. The connection of the user device 120, 130, and/or 140 to the access network and/or telecom network (as shown in FIGS. 2B and 2C which illustrate the core network management system 205 after the user devices 120, 130, and/or 140 have connected 244 and 246 to the telecom network 170) may cause the user device(s) to be operable as a third generation partnership project (3GPP) device. Advantageously, the user device 120 (e.g., a generic user device) may connect to the access network and/or telecom network (e.g., the core network) of one or more carriers, service providers, etc. even though the user device does not have a radio (e.g., a 5G radio, WiFi), SIM card reader, SIM card, and/or eSIM. In some examples, the connection of the gateway device to the access network and/or telecom network may cause the gateway device that includes the telecommunication network stack to be operable as a 3GPP device. The user device 120, N3IWF, telecom network 170, and any other suitable device, system, component, etc. may send and/or receive data 248, 250 between systems, components, etc. directly and/or indirectly.

As illustrated in FIG. 2D, in embodiments wherein an update of the telecommunication network stack is available, the core network management system 205 may be structured to generate one or more telecommunication network stacks 260. The core network management system 205, telecom network 170, N3IWF, user device 120, and any other suitable device, system, component, etc. may send and/or receive the telecommunication network stack 262 between systems, components, etc. directly and/or indirectly. In some examples, the user device 120 may update the telecommunication network stack 264. In turn, the user device 120 may provide a notice of installation of the telecommunication network stack 266 to the N3IWF. The user device 120 may run or otherwise execute the telecommunication network stack 268 that has been installed 270 such that the user device 120 may operate as a 3GPP device.

In some embodiments, the service provided to the user device 120 may be stopped or otherwise disabled as illustrated in FIG. 2E. The service provisioner 215, core network management system 205, user device 120, N3IWF, telecom network 170, and any other suitable device, system, component, etc. may send and/or receive a stop service request 280 between systems, components, etc. directly and/or indirectly. The user device 120 may disable connectivity 282 in response to receiving the stop service request 280. In turn, the user device 120 may provide a service stop notification 284 to the N3IWF. Alternatively or additionally, the service provisioner 215, core network management system 205, user device 120, N3IWF, telecom network 170, and any other suitable device, system, component, etc. may send and/or receive the service stop notification 284.

In some embodiments, the service provided to the user device 120 may be started, restarted, or otherwise enabled as illustrated in FIG. 2F. The service provisioner 215 may provide a restart service request 286 to the core network management system 205. The core network management system 205 may provide a start service request 288 to the user device 205. The user device 120 may enable connectivity 290 in response to receiving the start service request 288. In turn, the user device 120 may provide a service started notification 294 to the core network management system 205. Alternatively or additionally, the core network management system 205, user device 120, N3IWF, service provisioner 215, telecom network 170, and any other suitable device, system, component, etc. may send and/or receive the service started notification 294. In some examples, a connection request 296 may be provided by the user device 120 to the N3IWF. A connected notification 296 may be sent or otherwise received by the N3IWF and/or the user device 120. The user device 120, N3IWF, telecom network 170, and any other suitable device, system, component, etc. may send and/or receive data 299 between each respective system directly and/or indirectly.

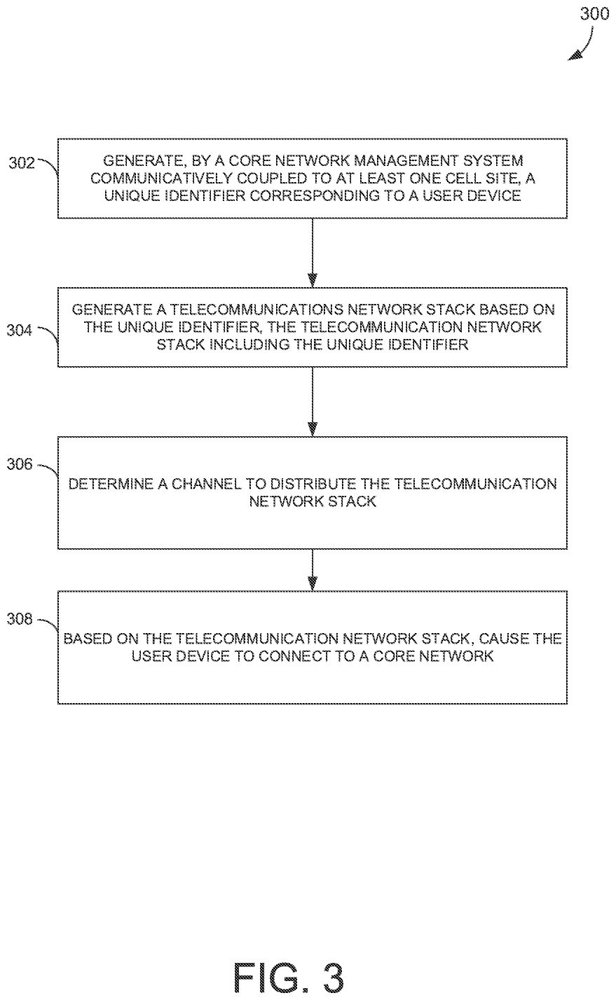

FIG. 3 depicts a flow diagram of an exemplary method 300 for connecting a user device to a telecommunication network, in accordance with implementations of the present disclosure. Initially at block 302 a unique identifier corresponding to a user device is generated by the core network management system. In this regard, the core network management system may generate unique SIM-free identification information that identifies the user device.

At block 304, a telecommunication network stack is generated based on the unique identifier. The telecommunication network stack may include the unique identifier in the telecommunication network stack or the core network management system may deliver the unique identifier with the telecommunication network stack. In some examples, the core network management system may generate a plurality of telecommunication network stacks that correspond to the user device. In further embodiments, the telecommunication network stack may be provided to the user device. Accordingly, the telecommunication network stack may be received and/or provided by a service provider system and/or Wi-Fi.

In some embodiments, at block 306, a channel (e.g., a control plane and/or a user plane) to distribute the telecommunication network stack is determined. In further embodiments, the core network management system may determine the channel and distribute the telecommunication network stack that includes the unique identifier to the user device. At block 308, the user device is caused to connect to an access network and/or or the telecom network (the 5G core network) based on the virtual telecommunication network. In this regard, the user device(s) may install one or more programmatic algorithms. The core network management system may inform the telecom network of the telecommunication network stack including the unique identifier. The connection of the user device(s) to the access network and/or the telecom network may cause the user device(s) to be operable as a 3GPP device or any other suitable device. The user device(s) utilize the programmatic algorithm(s) and the access network (the non-3GPP access network) to connect to the telecom network (the 5G core network) as a 5G UE using the unique identifier.

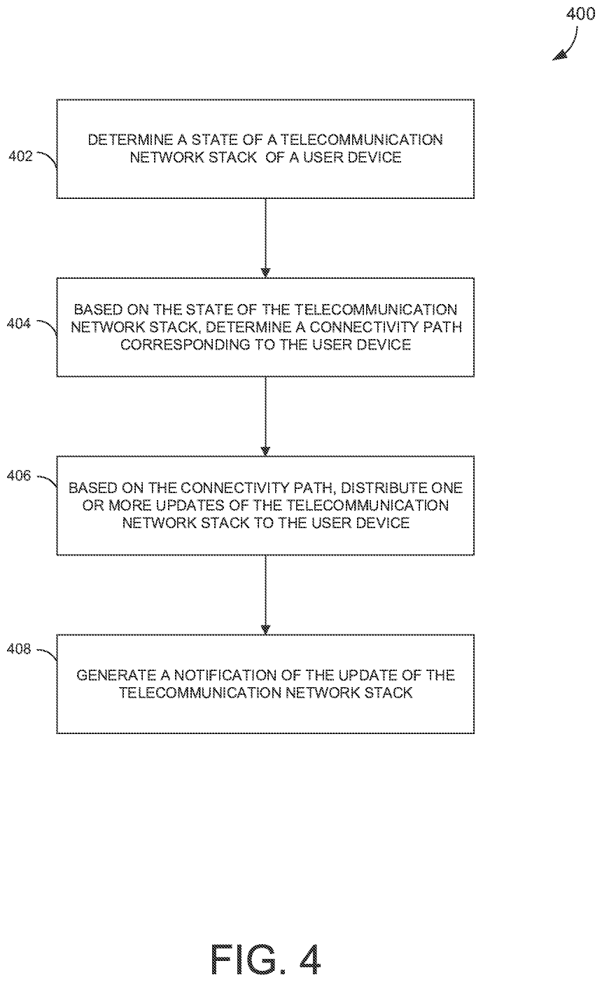

FIG. 4 depicts a flow diagram of an exemplary method 400 for updating a user device connected to a telecommunication network, in accordance with implementations of the present disclosure. Initially at block 402, the state of the telecommunication network stack (e.g., one or more programmatic algorithms) of a user device is determined. In this regard, the core network management system may determine that the telecommunication network stack (e.g., the programmatic algorithm(s)) needs to be updated. At block 404, a connectivity path corresponding to the user device(s) are determined based on the state of the telecommunication network stack. For example, the core network management system may determine the connectivity path for one or more updates of the programmatic algorithm(s).

In some embodiments, at block 406, one or more updates of the telecommunication network stack is distributed to the user device(s) based on the connectivity path. For example, the core network management system may distribute an update of the telecommunication network stack to the user device. Accordingly, the user device(s) install the update of the telecommunication network stack.

At block 408, a notification of the update of the telecommunication network stack is generated by the core network management system. For example, the core network management system may generate a notification that informs the telecom network (e.g., the 5G core network) of the update of the telecommunication network stack. The user device(s) may utilize the update of the telecommunication network stack to connect to the telecom network as a 5G UE using the unique identifier.

Referring to FIG. 5, a block diagram of an example of a computing device 500 suitable for use in implementations of the technology described herein is provided. In particular, the exemplary computer environment is shown and designated generally as computing device 500. Computing device 500 is but one example of a suitable computing environment and is not intended to suggest any limitation as to the scope of use or functionality of the invention. Neither should computing device 500 be interpreted as having any dependency or requirement relating to any one or combination of components illustrated. In aspects, the computing device 500 may be a base station. In another embodiment, the computing device 500 may be UE capable of two-way wireless communications with an access point. Some non-limiting examples of the computing device 500 include a base station, a controller at a base station, a backhaul server, a personal computer, a cell phone, current UE, legacy UE, a tablet, a pager, a personal electronic device, a wearable electronic device, an activity tracker, a laptop, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

As shown in FIG. 5, computing device 500 includes a bus 502 that directly or indirectly couples various components together. The bus 502 may directly or indirectly one or more of memory 504, processor(s) 506, presentation component(s) 508 (if applicable), radio(s) 510, input/output (I/O) port(s) 512, input/output (I/O) component(s) 514, power supply 516, and/or transmitter(s) 518. Although the components of FIG. 5 are shown with lines for the sake of clarity, in reality, delineating various components is not so clear, and metaphorically, the lines would more accurately be grey and fuzzy. For example, one may consider a presentation component(s) 508 such as a display device to be one of I/O components 514. Also, the processor(s) 506 may include memory 504, in another example. The present disclosure hereof recognizes that such is the nature of the art, and reiterates that FIG. 5 is merely illustrative of an example of a computing device 500 that may be used in connection with one or more implementations of the present disclosure. Distinction is not made between such categories as “workstation,” “server,” “laptop,” “handheld device,” etc., as all are contemplated within the scope of the present disclosure and refer to “computer” or “computing device.”

Memory 504 may take the form of memory components described herein. Thus, further elaboration will not be provided here, but it should be noted that memory 504 may include any type of tangible medium that is capable of storing information, such as a database or data store. A database or data store may be any collection of records, files, or information encoded as electronic data and stored in memory 504, for example. In one embodiment, memory 504 may include a set of embodied computer-readable and executable instructions that, when executed, facilitate various functions or elements disclosed herein. These embodied instructions will variously be referred to as “instructions” or an “application” for short.

Processor(s) 506 may be multiple processors that receive instructions and process them accordingly. Presentation component(s) 508, if available, may include a display device, an audio device such as a speaker, and/or other components that may present information through visual (e.g., a display, a screen, a lamp (LED), a graphical user interface (GUI), and/or even lighted keyboards), auditory, and/or other tactile or sensory cues.

Radio(s) 510 represents one or more radios that facilitate communication with a wireless telecommunication network. For example, radio(s) 510 may be connected to one or more antenna elements through a physical path. Illustrative wireless telecommunications technologies include CDMA, GPRS, TDMA, GSM, and the like. Radio(s) 510 might additionally or alternatively facilitate other types of wireless communications including Wi-Fi, WiMAX, 4G, 3G, 4G, LTE, mMIMO, 5G, NR, VoLTE, and/or other VoIP communications. As can be appreciated, in various embodiments, radio(s) 510 may be configured to concurrently support multiple technologies, as previously discussed herein. As such, each of many radio(s) 510 may be used to separately control portions of an antenna array, for example, where at least one portion utilizes a distinct technology relative to another portion in the same antenna array or at the same base station or cell site. A wireless telecommunication network might include an array of devices, which are not shown so as to not obscure more relevant aspects of the invention. Components such as a base station, a communications tower, or even access points (as well as other components) can provide wireless connectivity in some embodiments.

The input/output (I/O) ports 512 may take a variety of forms. Exemplary I/O ports 512 may include a USB jack, a stereo jack, an infrared port, a firewire port, other proprietary communications ports, and the like. Input/output (I/O) components 514 may comprise keyboards, microphones, speakers, touchscreens, and/or any other item usable to directly or indirectly input data into the computing device 500.

Power supply 516 may include batteries, fuel cells, and/or any other component that may act as a power source to supply power to the computing device 500 or to other network components, including through one or more electrical connections or couplings. Power supply 516 may be configured to selectively supply power to different components independently and/or concurrently.

Finally, regarding FIGS. 1 through 5, it will be understood by those of ordinary skill in the art that the environment(s), system(s), and/or methods(s) depicted are not intended to limit the scope of use or functionality of the present embodiments. Similarly, the environment(s), system(s), and/or methods(s) should not be interpreted as imputing any dependency and/or any requirements with regard to each component, each step, and combination(s) of components or step(s) illustrated therein. It will be appreciated by those having ordinary skill in the art that the connections illustrated the figures are contemplated to potentially include methods, hardware, software, and/or other devices for establishing a communications link between the components, devices, systems, and/or entities, as may be utilized in implementation of the present embodiments. As such, the absence of component(s) and/or steps(s) from the figures should be not be interpreted as limiting the present embodiments to exclude additional component(s) and/or combination(s) of components. Moreover, though devices and components in the figures may be represented as singular devices and/or components, it will be appreciated that some embodiments can include a plurality of devices and/or components such that the figures should not be considered as limiting the number of devices and/or components.

It is noted that aspects of the present invention are described herein with reference to block diagrams and flowchart illustrations. However, it should be understood that each block of the block diagrams and/or flowchart illustrations may be implemented in the form of a computer program product, an entirely hardware embodiment, a combination of hardware and computer program products, and/or apparatus, systems, computing devices/entities, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

Additionally, as should be appreciated, various embodiments of the present disclosure described herein can also be implemented as methods, apparatus, systems, computing devices/entities, computing entities, and/or the like. As such, embodiments of the present disclosure can take the form of an apparatus, system, computing device, computing entity, and/or the like executing instructions stored on a computer-readable storage medium to perform certain steps or operations. However, embodiments of the present disclosure can also take the form of an entirely hardware embodiment performing certain steps or operations.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned may be completed without departing from the scope of the claims below. Certain features and subcombinations are of utility and may be employed without reference to other features and subcombinations and are contemplated within the scope of the claims.

The invention claimed is:

1. A method for connecting a user device to a telecommunication network, the method comprising:
generating, by a core network management system communicatively coupled to at least one cell site, a unique identifier corresponding to a user device;
generating a telecommunication network stack based on the unique identifier, the telecommunication network stack comprising the unique identifier;
determining a channel to distribute the telecommunication network stack; and
based on the telecommunication network stack, causing the user device to connect to a telecom network.

2. The method of claim 1, wherein the channel comprises at least one of a control plane or user plane.

3. The method of claim 1, wherein the telecommunication network stack is to cause the user device to be operable as a third generation partnership project device.

4. The method of claim 1, wherein the user device comprises at least one adapter.

5. The method of claim 1, wherein the telecommunication network stack comprises the unique identifier.

6. The method of claim 1, wherein the core network management system is structured to generate one or more telecommunication network stacks.

7. The method of claim 1, wherein the core network management system is structured to cause the user device to connect to an access network.

8. Computer-readable storage media having computer-executable instructions embodied thereon that, when executed by one or more processors, cause the processors to:
generate a unique identifier corresponding to a user device;
generate a telecommunication network stack based on the unique identifier, the telecommunication network stack comprising the unique identifier;
determine a channel to distribute the telecommunication network stack; and
based on the telecommunication network stack, cause the user device to connect to an access network and a telecom network.

9. The computer-readable storage media of claim 8, wherein the channel comprises at least one of a control plane or user plane.

10. The computer-readable storage media of claim 8, wherein the telecommunication network stack comprises the unique identifier.

11. The computer-readable storage media of claim 8, wherein the core network management system is to provide the unique identifier with the telecommunication network stack.

12. The computer-readable storage media of claim 8, wherein the access network comprises a 5G access network, and wherein the telecom network comprises a 5G core.

13. A system for connecting a user device to a telecommunication network, the system comprising:
a user device; and
a core network management system communicatively coupled to at least one cell site and the user device, the core network management system structured to:
generate a unique identifier corresponding to the user device;
generate a telecommunication network stack based on the unique identifier, the telecommunication network stack comprising the unique identifier;
determine a channel to distribute the telecommunication network stack; and
based on the telecommunication network stack, cause the user device to connect to a telecom network.

14. The system of claim 13, wherein the channel comprises at least one of a control plane or user plane.

15. The system of claim 13, wherein the user device comprises at least one of a generic device or radio-free device.

16. The system of claim 13, wherein the telecommunication network stack comprises the unique identifier.

17. The system of claim 13, wherein the core network management system is structured to generate one or more telecommunication network stacks.

18. The system of claim 13, wherein the core network management system is structured to cause the user device to connect to an access network.

19. The system of claim 13, wherein the telecommunication network stack is to cause the user device to be operable as a third generation partnership project device.

20. The system of claim 13, wherein the core network management system is to provide the unique identifier with the telecommunication network stack.
